(19) United States
(12) Patent Application Publication
(10) Pub. No.: US 2006/0278660 A1
(43) Pub. Date: Dec. 14, 2006

(54) Automotive grease gun

(76) Inventor: Ling Zhang, Rowland Heights, CA (US)

Correspondence Address: Office of Donald Grant Kelly, Suite 420, 515 King Street, Alexandria, VA, 22314, US

(21) Appl. No.: 11/147,205

(22) Filed: Jun. 8, 2005

(51) Int. Cl. G01F 11/00

(52) U.S. Cl. 222/262; 222/333

(57) ABSTRACT

A shoulder supported, hand directed automotive grease gun in which a reciprocating piston transfers fluid from a supply tube to an outlet conduit. A battery powered motor and gear transmission rotate a disc on which is mounted an eccentric pin. The pin forcibly moves a piston holder between low friction parallel guides so as to advance the piston with its transferred fluid toward the outlet conduit. A first spring constantly biases the piston holder toward the pin so that the piston reciprocates rapidly as the disc rotates. An adjustable spring-loaded ball seal unit with an adjustable spring seat controls flow of the fluid. A fluid supply tube heating device alters fluid density to also control fluid flow. An auxiliary shoulder strap relieves pressure on an operator's wrist and transfers backpressure and tool weight to the operators body.

### REFERENCE TO RELATED APPLICATIONS

Not applicable

### REFERENCE TO SEQUENCE LISTING

Not applicable

### BACKGROUND OF THE INVENTION

1. Field of the Invention

The invention disclosed and claimed herein relates to battery powered, hand manipulated fluid dispensing tools of the type typically referred to as grease guns, and more particularly to a cam and piston fluid ejection system acting against an adjustable check valve to control output.

2. Description of the Related Art

Hand manipulated fluid dispensers of the type employed as grease guns and the like generally include fluid pumps driven by power transmission systems including DC motors and associated power output gearing systems. Typically, as a final power transmission segment, a reciprocating piston or plunger interconnected to or engaged by the power transmission system acts in a first direction along a passageway to rapidly eject fluid, e.g., grease. The fluid exits by force through an outlet and into a tool outlet conduit leading to a delivery target location. In its second, or opposite, direction the piston or plunger permits fluid to exit a fluid supply container into the passageway for subsequent ejection.

In general, portable grease guns and the like include three overall tool components which may be present in a variety of mechanical formulations. First is the mechanical component where a rotational movement produced as output from a motor and its associated gearing is transformed to substantially linear reciprocal pumping movement causing a piston or plunger element to present a rapid pressurized force to eject the fluid.

The second component is the power generation and transmission system, itself, including a DC motor and associated gear set or motor output system. The third principal component of portable grease guns and the like is a handle, typically including an on/off power switch, a suitably configured hand-grip portion, and a power source (e.g., battery) often enclosed within a handle cavity. Again, typically, the battery power source may of the rechargeable type.

Additional components beyond the three just described may include a fluid material supply chamber in the form of a hollow housing (e.g., tubular in shape) adapted to be fitted with a charge or reservoir of fluid (e.g., grease) which itself may be contained within a tubular insert element. This charge is configured and positioned so as to deliver fluid material on demand to a charging area passageway where the reciprocating piston or plunger acts to eject it through a pumping action. A fluid material supply chamber may be tubular in shape, and may also be equipped with an internal spring-biased feeding plunger ensuring a consistent and continuous discharge of fluid into the charging area passageway.

Prior art portable fluid ejection or dispensing systems frequently include external delivery conduits or hoses with remote terminal fittings at their distal ends where ejected fluid, e.g. grease, is to be delivered or deposited under pressure. The hoses may generally be adapted to have proximal ends suitably connected to the dispensing tools adjacent their fluid exit openings, and configured to receive fluid expelled under the ejection force of the reciprocating pistons or plungers.

Closure seals for said exit openings may be biased into a closed position by spring elements so as to keep the exit openings closed when not forced open by the pumping movement of the piston. A typical seal may involve a ball element contained within a discrete sealing unit that is fastened in place by an externally accessible bolt or screw plug.

The patent granted to Post et al., U.S. Pat. No. 6,135,327 illustrates a battery operated liquid dispenser having a top mounted, battery powered motor. The motor in the Post et al. dispenser operates through a set of gears to move a yoke with an external slot. A plunger for ejecting fluid has a head retained in the slot such that the plunger is moved relative to the yoke and dispenses fluid under pressure.

The Post et al. patent also shows a ball check valve assembly serving as a closure seal, and held in place by a threaded plug. The ball check valve itself is biased by a seal spring. The plug serves to secure the check valve assembly in place, but is not adapted to adjust biasing pressure of the spring. The plunger, engaged by the yoke reciprocates to discharge fluid counter to the biased the closure seal.

In the Orlitzky et al. U.S. Pat. No. 6,408,985, another motor driven lubricator system is shown. In this disclosure, lubricant fluid is received and held in a chamber having an outlet. A movable member is part of a crank mechanism by which a movable member is moved toward the outlet to force lubricant therefrom.

Shih, et al., in their U.S. Pat. No. 5,609,274, show a portable grease dispensing device with a supply tube and a handle, wherein the driving unit has a rotatable output shaft and linkage unit interconnecting the shaft and a push rod so as to convert rotary motion of the shaft into reciprocating motion of the push rod.

Barry's U.S. Pat. No. 5,685,462 teaches an extruding apparatus with a feeder piston that extrudes fluid from a cylinder. The piston is moved by a throw mounted to a crank. Further disclosed by Barry is a fluid supply chamber in the form of a hollow housing having an inserted tube including a fluid charge. A spring element adds a biasing pressure against a feeding plunger.

Huang et al., in their Published U.S. patent application No. 2004/0231927, illustrate and describe another battery operated grease gun. This gun includes an electronic pressure regulator for controlling pressure of the grease. Also described is a pump system consisting of an eccentric pin-driven sliding block which, in turn, drives a reciprocating plunger. Huang et al. also describe a lubricant reservoir in the form of a cylindrical housing.

While the above discussed patent references clearly relate to the instant invention disclosed and claimed herein, none has the distinguishing features to be discussed below. In particular, and despite many years of incremental development in this field, the prior art suffers from relatively high friction mechanisms and a disregard for the need for important adjustability features to ensure smooth and ready delivery of fluid on demand. Additionally, prior art fluid ejection tools too often are far too delicate in mechanical design. Specifically, their point of failure most often lies in the mechanism for transferring rotary motion of reduction gearing to linear motion of the fluid ejection piston or plunger. This is especially a problem in ejection tools where no adjustment means is available to the user to accommodate field conditions.

### SUMMARY OF THE INVENTION

A principal objective of the present invention is to provide a portable grease gun that will have a power source, e.g., rechargeable battery, and with a fluid pumping mechanism in the form of a more efficient and effective pump plunger drive system. This system includes a low friction eccentric pin uniquely engaging a stable, robust spring biased plunger-holding device, so as to ensure a highly dependable and durable, yet relatively low cost, system.

A further objective is to manage fluid output or ejection pressure as operating conditions of such a tool may demand, and to do this through a combination of adjustment features including a biased ball seal passage closure unit, as well as heating elements within the fluid reservoir housing. A still further objective is to make such a tool principally shoulder supported and hand directed, by furnishing it with a unique shoulder strap element to shift the weight and backlash forces away from the user's wrist to thus avoid discomfort and painful injuries.

Other objects, features, and characteristics of the present invention will become apparent upon consideration of the following full description and the appended claims, with reference to the accompanying drawings, wherein like reference numerals designate corresponding elements in the various figures.

### BRIEF SUMMARY OF THE SEVERAL VIEWS OF THE DRAWINGS

Referring now to the accompanying drawings, constituting a part hereof, and with like reference characters indicating like parts, it is seen that:

FIG. 1 is a side elevation view of the fluid dispensing tool of the present invention;

FIG. 2 is a top perspective view of the fluid dispensing tool of the present invention;

FIG. 3 is a side elevation view similar to FIG. 1, and with a portion of the handle and motor housing removed to facilitate viewing internal elements;

FIG. 4 is a side view showing only the motor housing and gearing arrangement for the fluid dispensing tool of the present invention;

FIG. 5 is an elevation view of the motor housing and gearing arrangement of the present invention;

FIG. 6 is a top plan view of the fluid dispensing tool of the present invention with a portion of the housing enclosure removed revealing the pin driven piston arrangement;

FIG. 7 is a top perspective view further illustrating the eccentric pin driven piston arrangement along with such external details of a hose fitting and bleeder of the present invention;

FIG. 8 is a view similar to FIG. 7, but showing a pin sleeve element removed for clarity;

FIG. 9 is a perspective view of pin sleeve and plunger along with associated parts shown as disassembled for clarity;

FIG. 10 is a sectional view of the fluid dispensing tool of the present invention, showing the interrelationship of certain moving parts, including gearing, eccentric pin/piston arrangement, and check valve elements;

FIG. 11 is a sectional view similar to that illustrated in FIG. 10, but with a portion enlarged to show clearly the details of the check valve ball and spring elements, as well as unique adjustment features;

FIG. 12 is an exploded perspective view of the present invention with details of the check valve ball and spring assembly, particularly illustrating the adjustable features of the present invention, and with certain assembly elements illustrated in an exploded view labeled as “a;”

FIG. 12a is an enlarged perspective of the certain assembly elements from view “a” in FIG. 12;

FIG. 13 is a side elevation of the present invention, and in particular illustrating the fluid storage features;

FIG. 14 is a side elevation of the tubular-shaped fluid storage housing;

FIG. 15 is a cross-sectional view of the storage housing of FIG. 14 wherein the section is taken at A—A, and in particular illustrating a heating element therein.

### DETAILED DESCRIPTION OF THE INVENTION

It should be appreciated that the tool described as the present invention can have a number of applications, and that reference to grease gun or grease fluid is merely an economy of expression in the interest of efficiency and brevity. Thus, this reference in the title and description is without intent to limit the invention scope or in any respect to exclude equivalents.

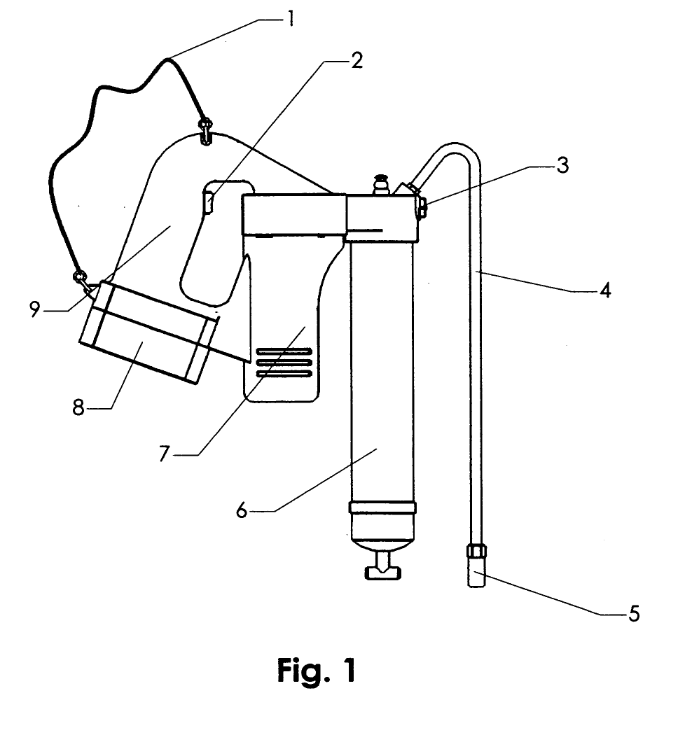

In terms of an operating system, the present invention includes four main work portions. Viewing FIG. 1, it is apparent that these main portions include a handle grip 9 a power supply, along with a power and transmission system shown generally at 7, fluid (e.g., grease) supply source or container 6 and tool output conduit 4. The handle grip 9 further includes an on-off switch 2.

To accommodate tool weight and backpressure forces during fluid delivery, an auxiliary shoulder belt or strap 1 is suitably attached to the handle grip 9. Extended periods of wielding such a portable device can be exhausting, given its weight, vibratory characteristics and inherent backlash or back pressure. Besides, the constant twisting effect on an operator's wrist can cause injury.

The shoulder strap 1 offers stress relief by shifting a major portion of tool weight and backlash to the operator's body. In other words, the tool becomes shoulder -supported and hand-directed. By facilitating the operator's application of shoulder strength and body weight, this shoulder belt 1 works in conjunction with other fluid flow management (to be described in detail herebelow) to deliver a smoother and more effective discharge, and with less effort and chance of injury.

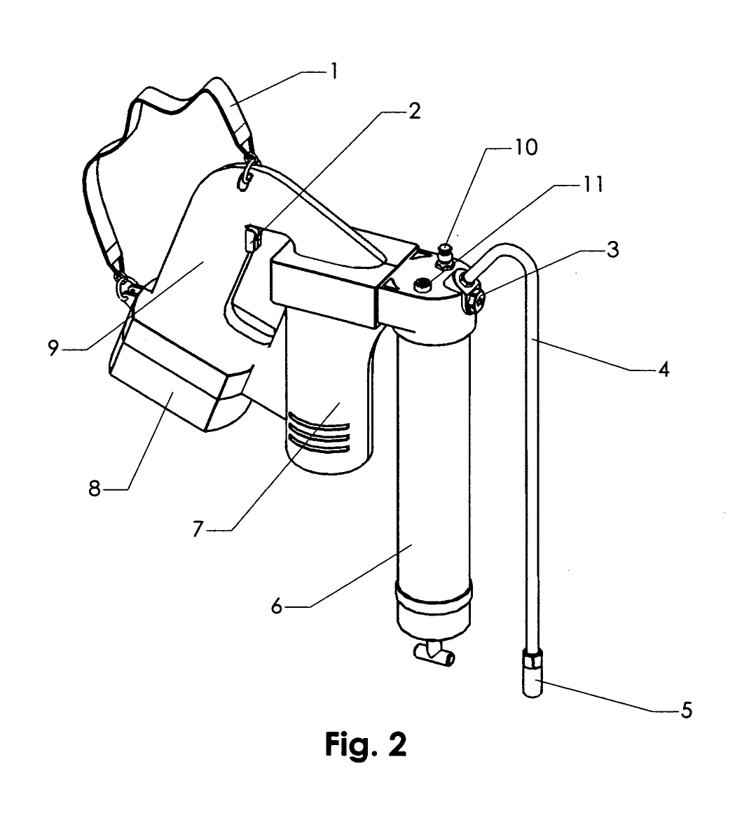

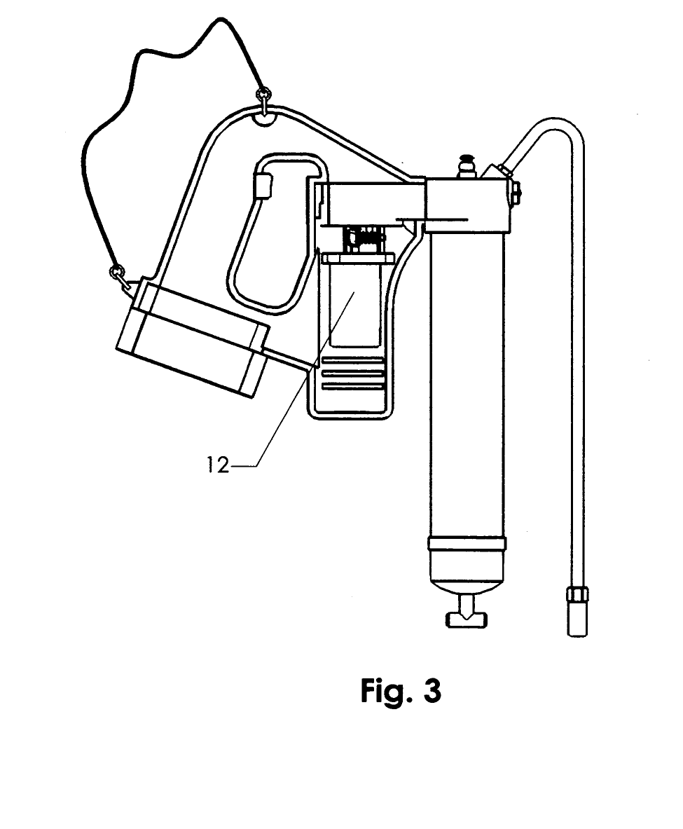

Stored within or directly adjacent handle grip 9 is a power source, shown at 8. The power source 8 is chosen from a variety of widely available rechargeable battery power units and assigned the primary role of powering DC motor 12 shown in FIG. 3. A tool outlet conduit or hose 4 is attached at a proximate end to a fluid exit, to be further described herebelow, and includes a suitable fitting 5 at the distal end thereof whereby fluid, e.g., lubricant, may be directed for targeted delivery. Additional conventional features are illustrated in FIG. 2, including a bleeder tap 10 and filler port 11.

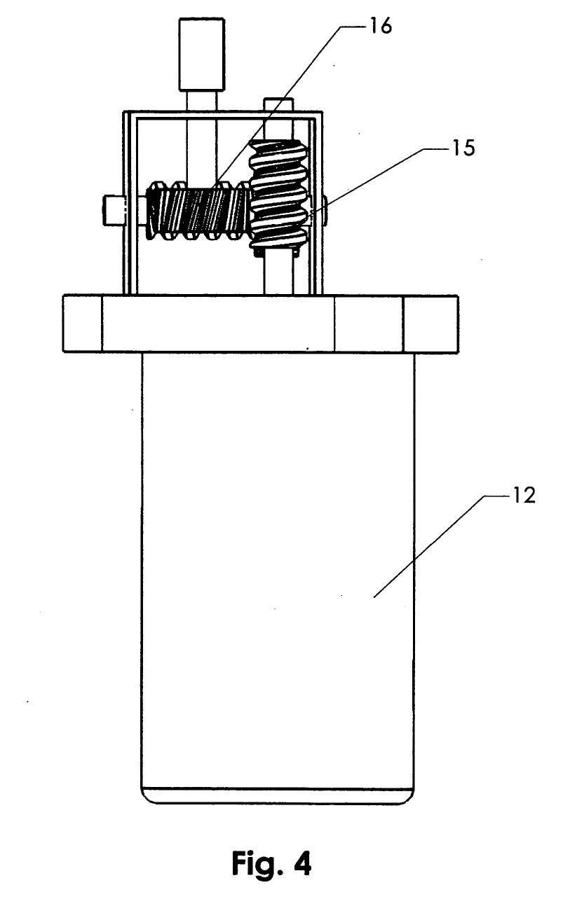

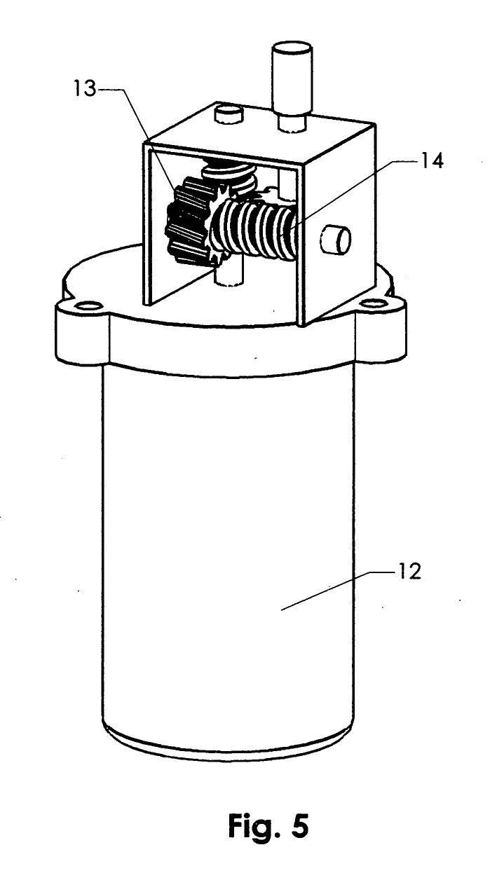

Driven by DC motor 12, as illustrated in FIGS. 4 and 5, are a series or train of reduction and transmission gears illustrated at 15, 13, 14, and 16. At this point the tool drive and transmission system serves to operate the fluid pumping mechanism, where motion is converted from rotary to linear. To this end, the output of gear 16 rotatably engages disc17 which is adapted to rotate about its central axis.

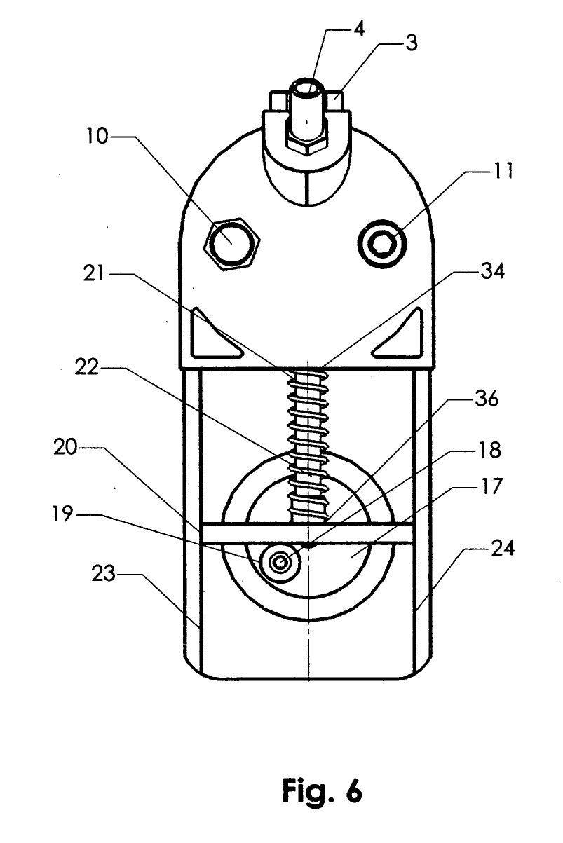

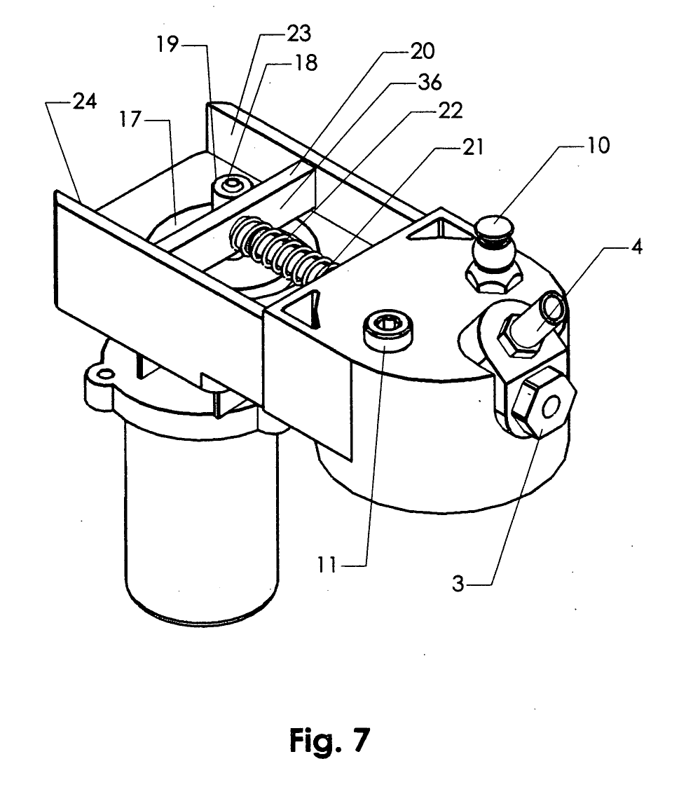

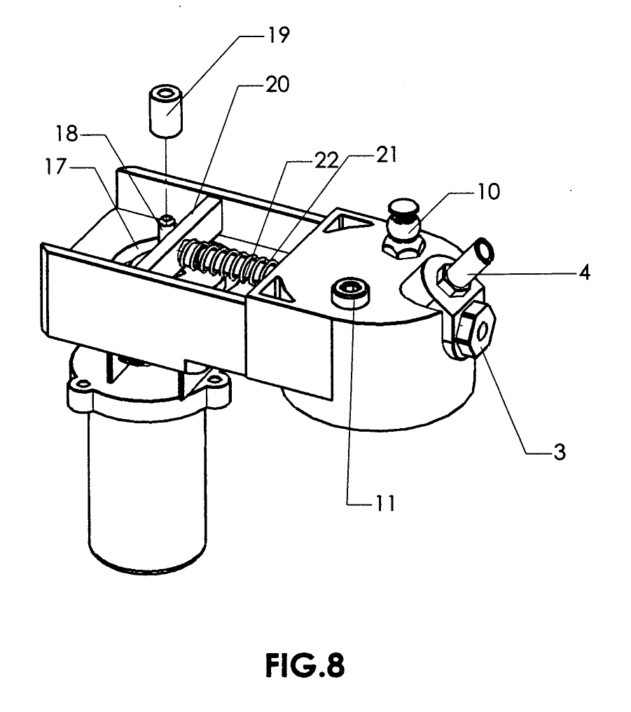

Attached or otherwise affixed to said disc is pin 18 which is eccentric, or spaced from said central axis. A low-friction sleeve 19 composed of well known low friction material is shown in FIGS. 6, 7 and 8 substantially covers pin 18. Sleeve 19 is mounted on pin 18 so as to be rotatable on its own axis when in moving engagement with piston holder 20 to be described as follows.

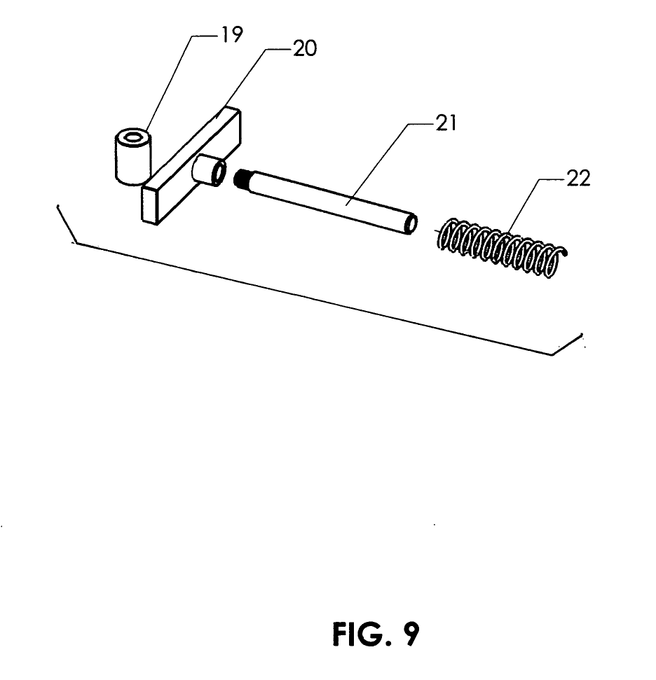

Pin 18, through its rotatable, substantially non-friction sleeve 19, directly engages a piston holder 20, itself machined, constructed and/or coated so as to present low friction characteristics. Piston 21 is suitably interconnected or attached at a first end thereof, for example by a threaded connection or the like, to piston holder 20 as is further illustrated in FIG. 9. Of course, said piston could be integral with said holder, as well. A second end of said piston 21 extends into housing passageway as will be described.

Surrounding piston 21 is a first compression spring 22. Spring 22 has a first end engaging piston holder 20 at a point on holder surface 36 where piston 21 is attached or otherwise interconnected to said holder. A second end of said first spring 22 engages said tool housing 34 at a point where said piston enters a housing passageway, so as to continuously and flexibly bias holder 20 toward pin 18.

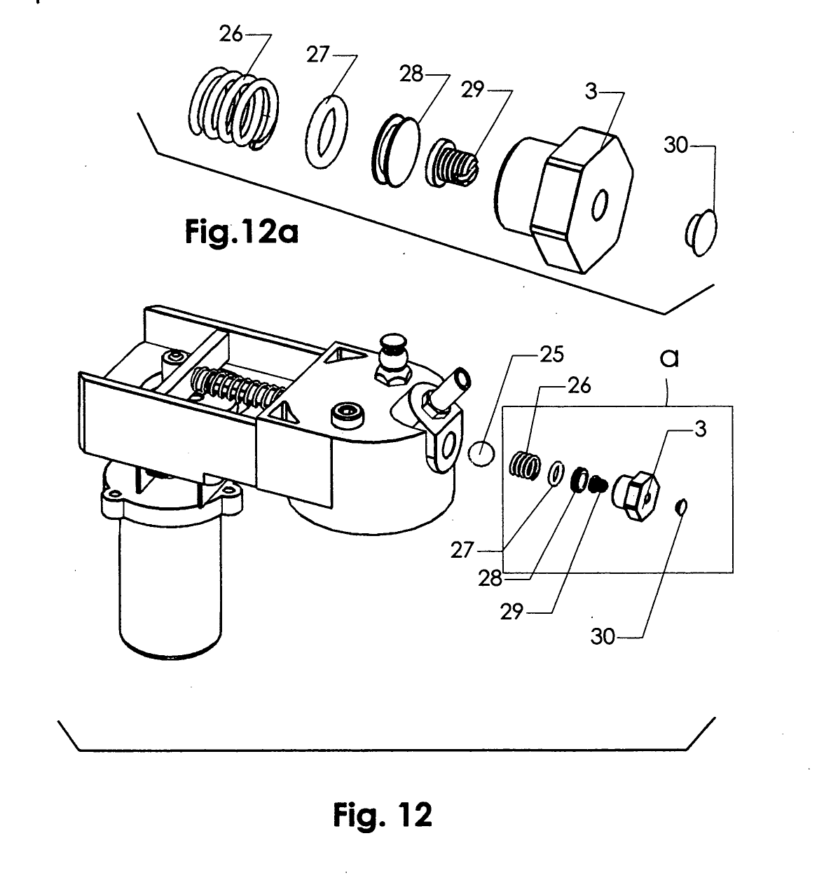

Biased by first spring 22 toward pin 18, piston holder 20 is thus moved in one direction by the force of the eccentric pin 18 mounted on rotating disc 17 and returned in its rapid reciprocal path by the force of spring 22. Piston holder 20 is adapted to slidably fit between parallel guide portions 23 and 24 of said tool housing, viewed as part of the tool housing (see FIG. 12). Importantly, such guide portions 23 and 24 along with piston holder 20 include substantially non-friction bearing surfaces. Thus, piston holder 20 is confined and stabilized in its rapid reciprocating motion by said parallel guide portions 23, 24.

With this elegantly simple, low cost and low friction mechanical design for the fluid pumping mechanism, piston 21 is thus driven along a pathway or passageway adjacent said fluid supply source so as to push fluid exiting said supply source toward said tool outlet conduit.

Most power loss in existing fluid pumping systems has been experienced at the point where rotary motion is converted to the reciprocal dispensing motion. Through the use of this novel, low friction pin-driven piston holder system, the fluid injection or dispensing tool described herein operates more efficiently than the prior art systems.

The guided, confined motion of the piston holder between guides 23 and 24, coupled with the steadying or stabilizing effect of the first compression spring 22, reduces damaging vibration and misalignment of moving parts found to be common in past configurations. Additionally, the first compression spring 22 works cooperatively with a second compression spring within a check valve spring adjustment system to be described as follows.

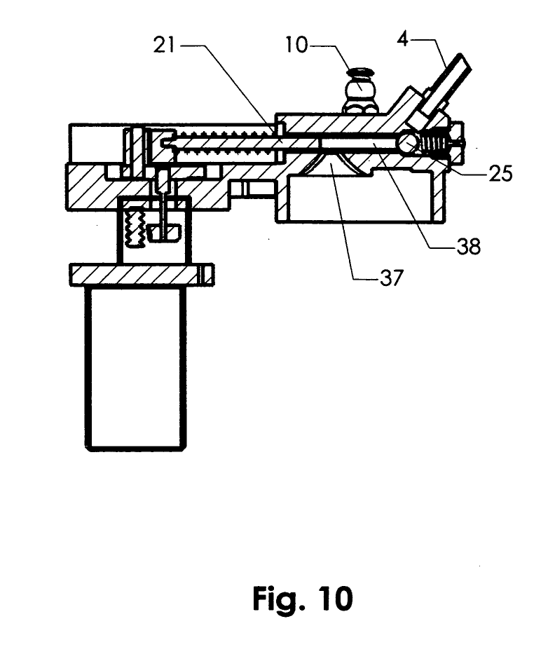

FIG. 10 illustrates an exit where fluid material would emerge from its reservoir within fluid supply source container 6 (removed in this view) through a reduced nozzle area 37 and into an output zone (or piston passageway) 38 to be impinged upon by the reciprocating piston 21. As the piston moves along a pathway to the right as viewed in FIG. 10, it imparts a rapidly repeated pressure to the fluid, rapidly pressing said fluid under an ejection force toward tool outlet conduit 4 attached at its proximate end at a fluid exit area of the tool housing

A ball seal unit is positioned along said passageway between said piston 21 and said tool outlet conduit 4, and adapted to block said passageway between said piston and said tool outlet conduit. Said ball seal unit including as a component thereof a blocking ball 25 biased by second compression spring 26. The term “ball” in the context of, and within the scope of the appended claims, is meant to extend to ball-like, rounded, substantially spherical or hemispherical surfaces.

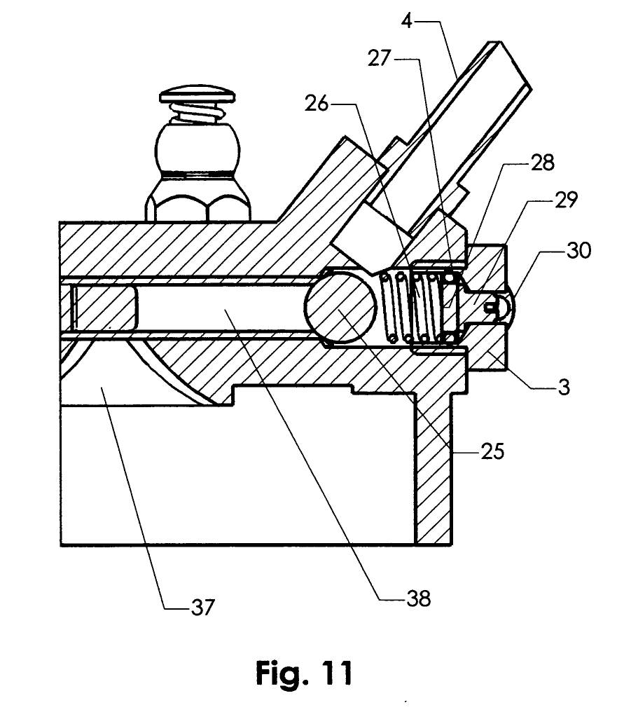

Said second compression spring is shown as seated against a spring seat 28, as best viewed in FIGS. 11, 12 and 12a. Thus, the exit area is normally blocked by sealing ball 25 biased against the fluid material flow by spring 26. Spring 26 is positioned within the ball seal unit between ball seal 25 and O-ring 27 pressed against seat 28.

Typical of prior art devices of this type, the pressure provided by a ball seal mechanism is pre-set at the factory. While different settings of such a mechanism will determine the output pressure of fluid being delivered to the target, there is no ready way to adjust this pressure (post-assembly) while in the field according to present needs, conditions of the surrounding environment, fluid characteristics and delivery requirements. The present invention successfully addresses this shortcoming in the prior art, and in a way that uniquely combines with other adjustment features of the present invention.

The ball seal 25, its spring 26 and O-ring 27 are held in place by a valve bolt 3, threaded (not shown) in a conventional manner to the tool housing (see FIG. 11). The pressured fluid forces ball seal 25 to compress its biasing spring 26 against O-ring 27 and seat 28 to a point (or position) where the fluid exits. Of course, the rapid movement of plunger 21 produces the effect of a substantially continuous flow of fluid exiting through conduit 4 as long as the tool operator engages the trigger switch 2.

Experience has shown, however, that differences or changes in viscosity or other flow characteristics of the fluid to be ejected or discharged can pose problems in obtaining desirable output volume and/or pressure. For example, surrounding temperatures can have either a softening or hardening effect on the fluid to be pumped. Where the fluid is less dense or more flowable, a considerable amount, too much in fact, may be ejected with bad results with respect to the work being performed.

On the other hand, when the fluid is dense and insufficiently flowable a considerable amount of power may be drawn so as to deplete the battery. Beyond that the tool may be damaged from the severe pressures involved. To address such problems, the present invention includes a unique adjustment mechanism as illustrated in FIGS. 11, 12 and 12a. Valve bolt 3 includes an internal adjustable lug 29. Adjustment lug 29 is generally protected by cover 30, and is fitted within valve bolt 3 by a conventionally internal threaded connection, not shown.

At its outermost end, adjustable lug 29 is provided with a slot, accessible when cover 30 is removed, and adapted to be engaged by a conventional adjusting element such as a screwdriver and the like. Of course, a variety of other, equivalent configurations could be employed to reach the same end. For example, adjustable lug 29 could have an externally extended head provided with two or more flattened portions to be engaged by a wrench.

When conditions require an adjustment to the flow of fluid such as grease and the like, to permit either an increased flow rate or reduced flow rate, the cover 30 is removed and a tool is applied to turn lug 29. The turning of lug 29 serves to move the seat 28 such that it de-compresses or compresses spring 26. Thus, the resistive force of ball seal 25 is adjusted accordingly.

By adjusting the spring seat 28 position, the operator achieves a desired preload on the spring 26; and, thus the operator achieves a desired exit pressure or flow by selectively countering the ejection force of the plunger. This is because a large preload will require a higher pressure to move the ball seal 25. Exiting fluid generally is delivered under high pressure. Less preload or pre-set resistance, of course, will result in a lower fluid pressure at exit. Working in conjunction with the compression spring 22, spring 26 provides a remarkably effective dampening effect, and considerable control of the flow of the fluid through and out of the tool.

Another feature of the present invention further addresses the problem of fluid viscosity changes, particularly in colder climes where stiffening or solidifying of the fluid results in an increased density. The increased density, in turn, brings about constricted fluid flow and reduction of working efficiency.

As discussed above, when the fluid resists movement along its intended pathway, less fluid material is expelled and more battery power is consumed, causing increased battery drain. Similarly, increased work demand imposes a strain on the DC motor, reducing its operational life. Likewise, the operator must struggle against the backpressure in the tool's passageways, and work against the clock to get the job done in a timely manner.

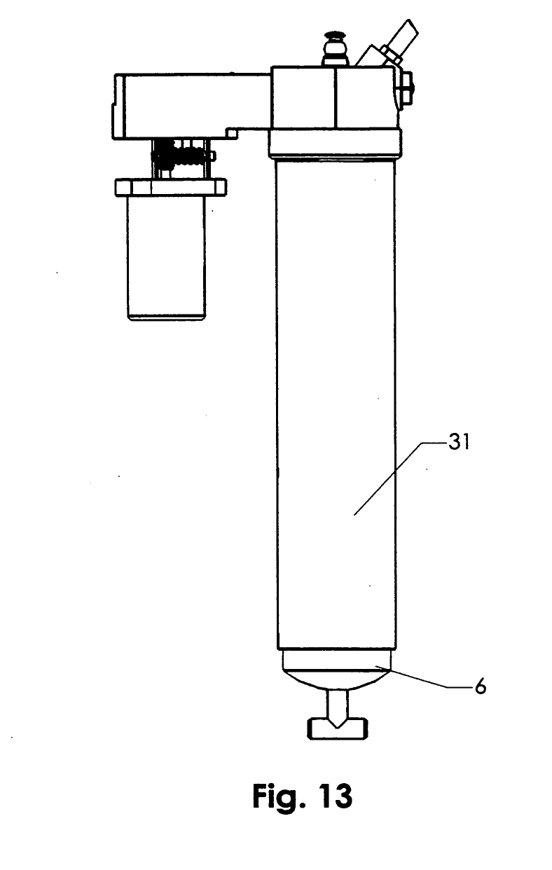

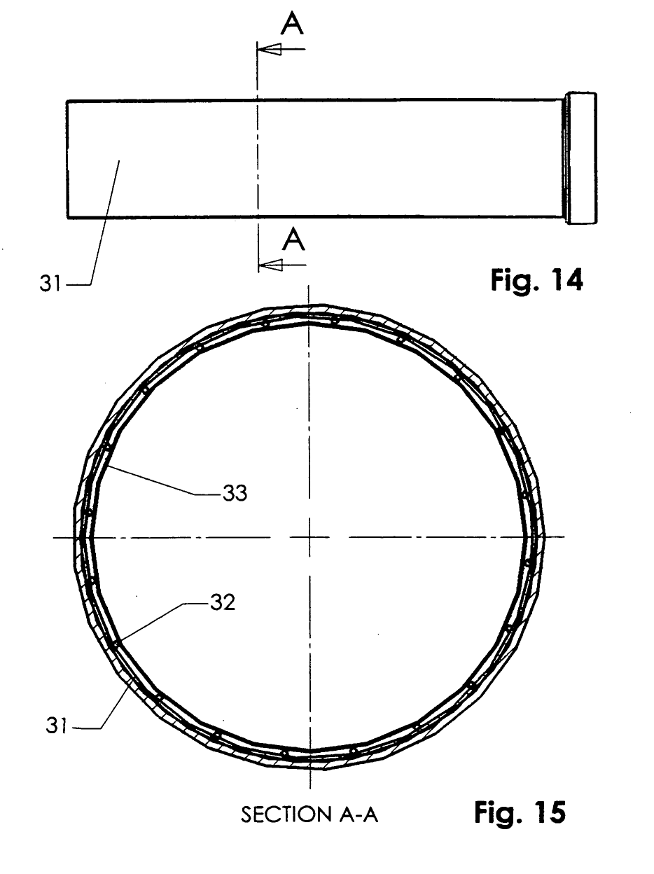

To address this problem, the present invention modifies the grease supply source. This modified tube is shown as tube 31 in FIGS. 13-15. Tube 31 is fitted with an internal heating element in the form of a layer of wiring 32. This heating element itself may take a tubular configuration. The heating element may include a wire mesh construction 32 and/or have a metal foil material covering 33.

A fluid supply tube would be placed within said tube 31, and the wiring is selectively connected to battery 8 such that the wiring is caused to be heated. Heat from the wiring maintains a more workable density in the fluid flow.

Upon careful reading of the foregoing specification and the accompanying drawings, it will be evident that this invention is susceptible of modifications, combinations, and alterations in a number of ways which may differ from those set forth. The particular arrangements disclosed herein are intended as illustrative only and in no way limiting as to the scope of the invention which is to be given full breadth of claims appended hereto and any and all equivalents thereof. What is claimed is:

1. In a fluid dispensing tool of the type including a tool housing, a fluid material supply source, a tool outlet conduit, a handle, a power source, and a motor and transmission system operating a fluid pumping mechanism, the improvement comprising:
said fluid pumping mechanism including a piston adapted to reciprocate along a passageway within said housing;
said fluid pumping mechanism further including a disc adapted to be rotatably driven about a central axis by said transmission system, said disc further including a pin mounted thereon so as to be eccentric with respect to said central axis;
a holder for said piston mounted within said housing and adjacent said pin, said piston interconnected at a first end thereof to said holder and having a second end thereof extending into said passageway;
a first compression spring adapted to engage said holder and said housing so as to bias said holder toward and against said pin;
said fluid material supply source positioned with a fluid material exit into said passageway;
whereby said fluid dispensing motor and transmission system impart a rotary motion to said disc such that action of said pin against said piston holder translates said rotary motion into a linear motion of said piston against said fluid material, thus moving said fluid material under an ejection force toward said outlet conduit.

2. The fluid dispensing tool of claim 1 wherein said pin includes a low friction
sleeve rotatably mounted thereon, said sleeve adapted to movingly engage said piston holder.

3. The fluid dispensing tool of claim 1 wherein said first compression spring surrounds said piston;
said first compression spring further engages said piston holder at a first point where said piston is interconnected at its first end to said piston holder, and engages said housing at a second point where said second end of said piston extends into said passageway.

4. The fluid dispensing tool of claim 1 wherein a ball seal unit is positioned along said passageway and adapted to block said passageway between said piston and said tool outlet conduit;
said ball seal unit including a ball biased by a second compression spring, said second compression spring seated against a spring seat.

5. The fluid dispensing tool of claim 4 wherein said ball seal unit includes an adjustment lug adapted to incrementally move said spring seat;
whereby preload of the ball seal unit may be set to counter said ejection force such that dispensing fluid pressure can be controlled.

6. The fluid dispensing tool of claim 1 wherein said fluid material supply source includes an internal heating element powered by said power source;
whereby said fluid material may be heated prior to dispensing so as to adjust the density and flowability thereof.

7. The fluid dispensing tool of claim 6 wherein said internal heating element is in the form of wire with metal foil.

8. The fluid dispensing tool of claim 7 wherein said fluid material supply source is a tubular member including a tubular heating element disposed therein.

9. The fluid dispensing tool of claim 1 wherein an ancillary shoulder strap is attached to said handle grip;
whereby an operator may relieve wrist pressure by shifting a major portion of tool weight and backlash to the operator's body.

10. The fluid dispensing tool of claim 1 wherein said tool housing includes parallel guide portions;
said piston holder is adapted to slidably fit between said guide portions;
whereby said piston holder is held stable and guided in a reciprocal movement along with said piston, against said first compression spring.

11. The fluid dispensing tool of claim 10 wherein said guide portions and said piston holder include substantially non-friction bearing surfaces.

12. The fluid dispensing tool of claim 1 wherein said power source is a rechargeable battery.

13. A fluid dispensing tool including a fluid material supply source, a tool housing including a tool outlet conduit, a rechargeable battery, and a battery powered motor and transmission system for operating a fluid pumping mechanism, said tool including:
a piston adapted to slide along a passageway to move said fluid material from said supply source to said tool outlet conduit;
a motor interconnected to a set of gears having a transmission output;
a disc attached to said output and rotatably driven thereby on an axis;
an eccentric pin affixed to said wheel at a position that is offset from said axis;
a piston holder adapted at a first side thereof to engage said pin;
said piston holder adapted at a second side thereof to attach to a first end of said piston;
a first compression spring engaged between said tool housing and said piston holder so as to bias said piston holder into substantially constant engagement with said pin;
whereby rotary motion of said disc is translated by said pin into rapid linear motion of said piston holder and piston to move fluid toward and into said tool outlet conduit.

14. The fluid dispensing tool of claim 13 wherein a ball seal unit is positioned along said passageway and adapted to block said passageway between said piston and said tool outlet conduit;
said ball seal unit including a ball biased by a second compression spring, said second compression spring seated against a spring seat.

15. The fluid dispensing tool of claim 10 wherein said ball seal unit includes an adjustment mechanism adapted to incrementally move said spring seat;
whereby adjustment of said spring seat preloads the ball seal unit so as to adjustably control fluid dispensing pressure.

16. The fluid dispensing tool of claim 9 further including a handle grip said grip further including:
a shoulder strap affixed to said grip and adapted to be supported on an operator's body;
whereby weight and forces of said tool may be absorbed by said operator's body rather than solely by said operator's wrist.

17. A battery powered fluid dispensing tool including a battery, fluid material supply tube, a tool outlet conduit, and gear transmission system for operating a fluid pumping mechanism, said tool including:
a piston adapted to move along a passageway to transfer said fluid material from said supply tube to said tool outlet conduit;
a motor and transmission output including an eccentric pin for driving said piston in a reciprocating linear motion;
said supply tube including an internal heating element attached to said battery for heating said fluid material prior to dispensing;
whereby the density and flow of said fluid material may be controlled.

18. The fluid dispensing tool of claim 17 wherein said internal heating element
is in the form of tubular shaped metal unit adapted to be inserted into said fluid material supply tube.

19. The fluid dispensing tool of claim 13 wherein a passageway sealing ball is positioned along said pathway between said piston and said tool outlet conduit, said ball is a component of a sealing ball unit including a second compression spring, said second spring seated against an adjustable spring seat.

20. The fluid dispensing tool of claim 19 wherein said ball seal unit includes an adjustment lug adapted to incrementally move said spring seat;
whereby preload of the ball seal unit may be set such that dispensing tool pressure can be controlled.
